(19) United States
(12) Patent Application Publication
(10) Pub. No.: US 2006/0272154 A1
(43) Pub. Date: Dec. 7, 2006

(54) Disposable gel-dispensing razor

(76) Inventor: Alfred Samuel Brevard, Capital Heights, MD (US)

Correspondence Address: OBER / KALER;c/o Royal W. Craig, 120 East Baltimore Street, Baltimore, MD, 21202, US

(21) Appl. No.: 11/385,230

(22) Filed: Mar. 21, 2006

Related U.S. Application Data
(60) Provisional application No. 60/686,429, filed on Jun. 2, 2005.

(51) Int. Cl. B26B 19/44

(52) U.S. Cl. 30/41

(57) ABSTRACT

A gel-dispensing disposable razor comprising a transparent plastic tubular handle with forked supports at one end, and a multi-bladed cartridge pivotally attached to the forked supports of the handle. A packet of shaving gel is resident in a reservoir formed in the handle, and a positive displacement pumping mechanism allows finger-operated extrusion of the gel out of the module, through the handle into a pivoting manifold which spreads the gel outward around the cartridge. The gel is extruded from the handle through the manifold which evenly extrudes the gel into laminar flow paths that emanate outward from around the pivoting cartridge. All of the tubular handle, carriage, manifold and positive displacement pumping mechanism are molded plastic components for cost-effective mass production. Moreover, the transparent handle provides an indication of the amount of gel left therein, and is further equipped with a series of spaced rubberized annular ribs to provide a sure hand-grip. The razor provides an exceptionally smooth shave for approximately 3-5 usages, after which the device can be conveniently disposed of.

### CROSS-REFERENCE TO RELATED APPLICATIONS

The present application derives priority from U.S. Provisional Patent Application No. 60/686,429; filed: 2 Jun. 2005.

### BACKGROUND OF THE INVENTION

1. Field of the Invention

The present invention relates to disposable razors for shaving and, in more particularly, to a disposable gel-dispensing razor with internal push-piston assembly for extruding shaving gel from an interior module outward around a conventional cartridge incorporating a series of razor blades.

2. Description of the Background

There are a variety of commercially available disposable razors that generally comprise a razor head with integral blade(s) and a razor handle that is permanently affixed to form a single disposable unit. Disposable razors are commonplace and account for a significant percentage of total razor sales in te United States and worldwide. These razors are designed to remain effective for a certain number of uses (typically 4-5) and, once the blades become dulled, are to be discarded in their entirety. Disposable razors are popular due to their low price and convenience.

More recently, a number of electric razors have become available that extrude shaving cream during operation, thereby softening the facial hair and improving the shave quality. These have become quite popular because they save time in applying the shave cream. However, the internal mechanisms for extruding the shave cream are comparatively complex electric pumps that are not well-suited for use in any variety of disposable razor.

Nevertheless, there have been a few attempts at disposable razors that contain a shaving lubricant. Some of these employ a pressurized canister (see Cohen, U.S. Pat. No. 5,337,478, Dallaine, U.S. Pat. No. 5,269,062, and Zeles U.S. Pat. No. 3,349,484, for example). Others employ a manually-operated pusher mechanism (see Perez, U.S. Pat. No. 3,703,765 and Kwak, U.S. Pat. No. 4,653,188, and U.S. Pat. No. 5,983,500 to da Silva issued Nov. 16, 1999. Still others employ a lubricant contained within the razor head (see Narijan, U.S. Pat. No. 5,072,512), or flexible reservoirs that pneumatically expel the lubricant (see Schauble, U.S. Pat. No. 4,809,432 and Olson U.S. Pat. No. 2,747,273).

The various mechanisms disclosed in the above-identified patents have their respective advantages and disadvantages, the main disadvantages being undue bulk (those containing lubricant in the head rather than the handle lack the proper balance of a conventional disposable, safety razor), complexity (and commensurate cost), and a lack of control (without a gradient or indexed manual pumping mechanism the prior art devices tend to eject too much foam).

Positive displacement pumping mechanisms are well-known in other contexts and hold promise for disposable razors as well. What has not been attempted is a positive displacement pumping mechanism in the context of a disposable razor, in which the razor handle serves as a reservoir for a module of shaving gel, a finger-operated push-piston in the handle allows precise control over extrusion of the gel from the module, through the handle and into a pivoting manifold for extruding the gel around a conventional cartridge incorporating a series of razor blades for even and uniform application to the face. This particular configuration would be amenable to cost-effective mass production entirely from molded plastic components.

### SUMMARY OF THE INVENTION

It is, therefore, a primary object of the present invention to provide a gel-dispensing disposable razor with precision manual extrusion of shaving gel from a module seated in a reservoir in the handle and outward through a pivoting manifold for extrusion around a multi-bladed pivoting cartridge, the cartridge, handle, pumping mechanism and manifold being conveniently incorporated into one integral and disposable unit.

It is another object to provide a gel-dispensing disposable razor as above that is compact, lightweight and inexpensive, thereby allowing consumers to have ready access to two shaving essentials, razor and shaving gel, in a disposable form that can be easily carried in a coat or pants pocket, a purse, or a back-pack.

It is another object to provide a gel-dispensing disposable razor as above that can be used with or without water, which dispenses shaving gel, and optionally scented shaving gel for women.

It is another object to provide a gel-dispensing disposable razor that is easy to use by effortless manual push-positive extrusion via a slider assembly.

It is still another object to eliminate the need for cumbersome shaving cream canisters that can leak onto belongings.

These and other objects are accomplished by a gel-dispensing disposable razor comprising a transparent plastic tubular handle with forked supports at one end, and a multi-bladed cartridge pivotally attached to the forked supports of the handle. The cartridge comprises a conventional pivoting cartridge with a plurality of blades seated in the head. A packet or “module” of shaving gel is resident in a reservoir formed in the handle, and a positive displacement pumping mechanism allows finger-operated extrusion of the gel out of the module, through the handle into a pivoting manifold which spreads the gel outward around the cartridge. The pumping mechanism comprises a finger-operated push-piston assembly that is slidably carried in the side-walls of the handle. The push-piston includes opposing finger-tabs accessible exteriorly of the handle for urging the push-piston against the gel module, thereby displacing the gel therefrom. The gel is extruded from the handle, and is split into two main flow paths by the manifold, and is further divided by a multi-channel distribution plenum in the manifold that evenly extrudes the gel into laminar flow paths that emanate outward from around the pivoting cartridge. All of the tubular handle, carriage, manifold and positive displacement pumping mechanism are molded plastic components for cost-effective mass production. Moreover, the transparent handle provides an indication of the amount of gel left therein, and is further equipped with a series of spaced rubberized annular ribs to provide a sure hand-grip.

The gel-dispensing disposable razor allows precision manual positive-displacement extrusion of shaving gel from the handle reservoir around the multi-bladed cartridge for shaving lubrication over approximately 3-5 usages, after which the device is conveniently disposed of.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 shows a perspective view of the gel-dispensing disposable razor 1 according to a preferred embodiment of the present invention.

FIG. 2 is a side view of the gel-dispensing disposable razor 1 of FIG. 1 illustrating the push-piston assembly.

FIG. 3 is a rear view of the gel-dispensing disposable razor 1 of FIGS. 1-2.

FIG. 4 is an exploded perspective view of the components of the gel-dispensing disposable razor 1 of FIG. 1, inclusive of the internal pumping mechanism and distribution manifold.

### DETAILED DESCRIPTION OF THE PREFERRED EMBODIMENTS

The present invention is a gel-dispensing disposable razor with positive displacement pumping mechanism in which the razor handle serves as a reservoir for shaving gel, and a finger-operated push-piston assembly slidably mounted in the handle to allow precise control over extrusion of the gel from the handle around a pivoting cartridge. The razor is equipped with a pivoting multi-channel distribution manifold for extruding the gel outward around the cartridge in an even and uniform application to the face. The entire gel-dispensing disposable razor is formed with molded plastic components and is well-suited for cost-effective mass production.

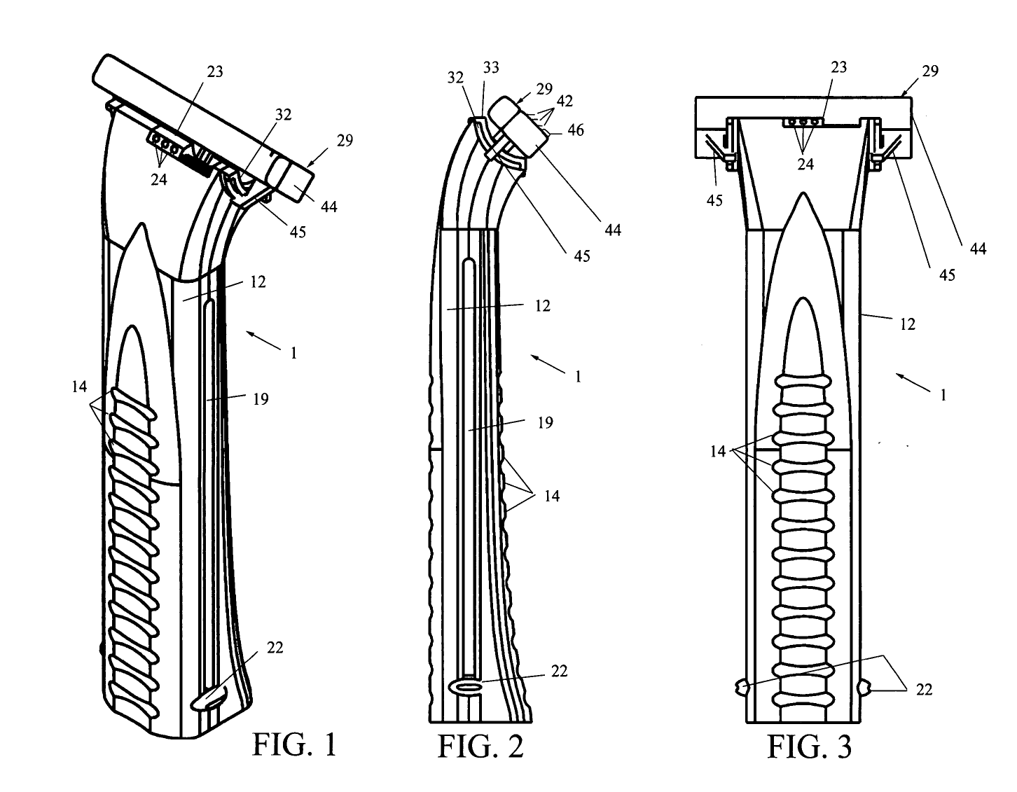

FIG. 1 shows the gel-dispensing disposable razor 1 according to a preferred embodiment of the present invention. FIG. 2 is a side view of the gel-dispensing disposable razor 1, and FIG. 3 is a rear view. With collective reference to FIGS. 1-3, the disposable razor 1 generally comprises an elongate two-piece tubular molded plastic handle 12 defining an internal reservoir for containing a packet or “module” of shaving gel, and a multi-bladed cartridge 29 mounted atop the handle 12. The plastic of handle 12 along its mid-section is preferably transparent or translucent to give a clear indication of the amount of gel left in the module (which is also transparent or translucent). The lengthwise extent of handle 12 is defined by a series of annular raised ribs 14 to provide a sure gripping surface. The sure-grip ribs 14 may be formed as molded rubber insets in a two-color two-material double-injection-molding process and, if desired, may be colorized to contrast with the transparent/translucent plastic to provide an aesthetically striking two-color appearance.

The shaving gel is incorporated in a module formed of cellophane, Mylar(tm) or like flexible material which is seated directly inside the handle 12, and is extruded therefrom by finger-actuation of an internal push-piston assembly including exterior finger tabs 22 on opposing sides of the handle 12, the internal push-piston assembly effecting positive displacement pumping of the gel out of its module. The module is frangible at its topmost end to facilitate extrusion (such as by perforations or a weakened seal of the module material). The gel is preferably a conventional glycerin shaving gel which may additionally include lanolin, emollients, emulsifiers, dispersants, plasticizers, and a foam stabilizer. With such gel it is intended that the disposable razor 1 can be used with or without running water. Moreover, the gel may additionally include optional fragrance for women.

The exterior finger tabs 22 protrude outwardly on opposing sides of the handle 12 and these are integrally formed with an internal push-piston (obscured) that abuts the lower end of the gel module. Finger tabs 22 are integrally formed on constricted necks that pass through elongate slots 19 defined in the sides of the handle 12 and running upwardly there along. Simple pushing of the finger tabs 22 urges the push-piston against the gel module (guided along the slots 19), which urges the shaving gel out through the frangible end of the gel module up through a channel inside the handle 12 where it is split by a manifold 23, first into two primary flow paths directed above and beneath the cartridge 29, and then into multiple flow paths defined by orifices 24 in the manifold 23 for even application of the gel.

The handle 12 is formed with two opposed support collars 32, support collars 32 providing an arcuate mounting for a conventional multi-bladed cartridge 29. In the preferred embodiment, the multi-bladed cartridge 29 comprises three closely-spaced angled hypo-allergenic blades 42 supported in a plastic open-faced carriage 44. The carriage 44 includes rearwardly-disposed clips 45 for clipping onto the opposed support collars 32 of the handle 12, the clips 45 allowing a degree of transverse freedom and the arcuate support collars 32 thereby allowing pivoting of the entire cartridge 29. Preferably, a conventional aloe strip 46 is adhered directly beneath the blades 42 across the carriage 29 to enhance the lubrication of the gel, thereby ensuring that the triple action hyperallergenic blades 42 deliver a smooth, close shave. The flow of gel outward from manifold 23 in advance the blades 42 is spread along the razor edges of the advancing blades 42, and the flow of gel outward from manifold 23 behind the blades 42 is deposited on the skin for lubrication during subsequent strokes. The gel foams upon contact, thereby improving lubrication. Preferably, a resilient plastic safety cap (not shown) is provided as with most conventional blade cartridges to protect exposure of the blades 42 when not in use. The entire above-described unit is preferably individually packaged in a cellophane wrapper for sterile use in hospitals and the like.

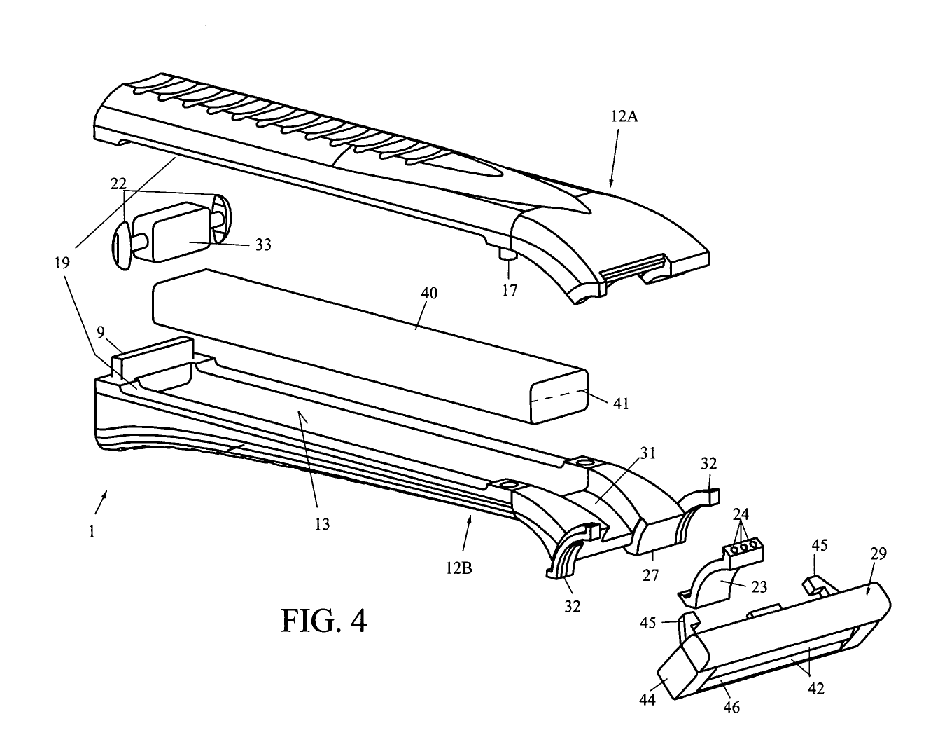

FIG. 4 is an exploded perspective view of the components of the gel-dispensing disposable razor 1 of FIG. 1, inclusive of the internal push-piston 33, gel module 40 and distribution manifold 23. The handle 12 is most conveniently formed as an elongate two-piece snap-fit structure including handle-halves 12A & 12B, with friction-fit pins 17 and/or tabs 9 formed on one half for press-fit insertion into mating receptacles 18. The joined halves of handle 12 define an internal reservoir 13 for containing a packet or “module” 40 of shaving gel, a gel channel 31 leading upward and out through the handle 12 toward the multi-bladed cartridge 29 which is snap-mounted atop the handle 12 as shown. As stated above, the shaving gel is incorporated into an elongate tubular module 40 is formed of cellophane, Mylar(tm) or like flexible material with a pressure-frangible end 41 defined by perforations, a weak heat weld, or the like. The gel module 40 is seated directly inside the reservoir 13 of handle 12 and when full substantially occupies the lengthwise extent of the handle 12. The razor 1 is initially sold with a fully charged module 40 of shaving gel incorporated within the handle 12, and the gel can be incrementally extruded therefrom by finger-sliding of the tabs 22, and thereby the push-piston 33. The push-piston 33 is a flat panel section conforming to the cross-section of the interior reservoir 13 of handle 12 and slidable there along to extrude the gel. The handle 12 may be formed with a rounded rectangular cross-section, in which case the piston 33 conforms. The push-piston 33 is integrally formed with the opposing finger tabs 22, which are joined to piston 33 via constricted necks, all of which may be integrally molded. The elongate slots 19 runnig substantially the length of the handle 12 are defined by partial slots in the two handle sections 12A & 12B which merge around the constricted necks of the push-piston 33 to slidably capture the push-piston 33 therein, and yet allow free sliding of the push-piston 33 under force of the finger tabs 22, thereby extruding gel up the handle and out through the distribution manifold 23 around the multi-bladed cartridge 29.

The distribution manifold 23 is formed as an outwardly concave member bounded by side-walls leading to distally-opposing plenums each defined by a series of orifices 24 (three each being shown). One half of handle 12 B is formed with a concave abutment surface 27 proximate the gel channel 31, the abutment surface 27 conforming to the backside of the manifold 23 to serve as a sliding surface. However, the manifold 23 overextends the abutment surface 27 across the gel channel 31 to intercept the flow of gel extruded through the flow channel 31. Thus, when the cartridge 29 is clipped onto the handle 12 it sandwiches the manifold 23 against the abutment surface 27 to provide a pivoting engagement for the manifold 23, manifold 23 thereby pivoting along with cartridge 29. Since the manifold 23 covers the gel channel 31 it intercepts the flow of gel, firstly dividing the flow into upper and lower primary flow paths, and then further directing the gel through the distally-opposing plenums and orifices 24 both above and below the advancing blades 42 of cartridge 29. Moreover, since manifold 23 pivots along with cartridge 29 the gel is always extruded onto the skin in close proximity (above and below) to the advancing blades 42 of cartridge 29.

In general operation, the internal push-piston 33 urges the shaving gel out from the module 40 and up through the gel channel 31 in handle 12 where it is split by manifold 23 into two even flow paths, and is then further distributed by the distally-opposing plenums and orifices 24 both above and below the advancing blades 42 of cartridge 29. The cartridge 29 clips onto the opposing arcuate supports 32 to form pivoted joints at the underside of cartridge 29. While the illustrated configuration can be integrally molded, many other pivoted arrangements may be well-suited. The design of cartridge clips 45 are derived from conventional pivoting shaving cartridges which allow pivoting of the entire cartridge within approximately a 30 degree range of pivoting motion. The design of pivoting manifold 23 and the support wall 27 of handle 12 is specifically designed to accommodate this same range of pivoting freedom and yet maintain the fluid coupling of the manifold 23 with the gel channel 31, as well as the position of the orifices 24 relative to the blades 42 throughout pivoting of the cartridge. Once the gel is urged fully through the manifold 23 it is extruded evenly at each side of the blade set 42, where it is spread evenly onto the facial skin, the gel being uniformly painted onto the skin by the razor edges of the three blades 42.

The above-described disposable gel-dispensing razor 1 is entirely plastic and may be formed with only six primary parts, one of which (the cartridge 29) is readily available. The razor is designed to be used with or without water, making it convenient and practical for travel and/or use in the field, such as in military encampments. In such use, the user need only manually slide the push-piston 33 via finger tabs 22 to release gel around the blades 42, whereupon the user may begin shaving in the usual fashion. The user effectively applies shaving gel for a smoother shave, and shaves away unwanted hair at the same time. The aloe strip 46 works synergistically with the gel to lubricate, and the triple action hyperallergenic blades 42 deliver a smooth, close shave. The disposable razor 1 is designed to give approximately 3-5 shaves depending on usage. Specifically, given dimensions of handle 12 which conform to typical disposable razors, the present gel reservoir 13 and modules 40 each can hold approximately one ounce of gel which is believed sufficient for approximately 3-5 uses. This also coincides with the expected lifetime of the blades 42, and when the gel is gone and/or the blades 42 are dull the unit 1 is simply discarded.

It should now be apparent that the above-described gel-dispensing disposable razor 1 allows precision manual positive-displacement extrusion of shaving gel from the handle 14 reservoir through the multi-bladed cartridge 29, and the cartridge 29, handle 12, pumping mechanism and distribution manifold 23 are conveniently incorporated into an integral and disposable unit for convenience of use. The assembly 1 is compact, lightweight and inexpensive to manufacture, thereby allowing consumers to have ready access to two shaving essentials, razor and shaving gel, in a 3-5 use disposable form that can be easily carried in a coat or pants pocket, a purse, or a back-pack. This eliminates the need for cumbersome shaving cream canisters that can leak onto belongings.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A gel-dispensing disposable razor, comprising:
a tubular handle having cartridge supports at one end, an internal reservoir, and an internal channel leading outward from said reservoir between said cartridge supports;
a blade cartridge attached to the cartridge supports of said handle;
a frangible packet containing shaving gel resident in the reservoir of said tubular handle;
a positive displacement pumping mechanism comprising a slidable push-piston resident in said handle reservoir for displacement of said gel from said packet; and
a distribution manifold in communication with the internal channel of said handle for extruding the gel outward peripherally around said blade cartridge for even and uniform application to the face.

2. The gel-dispensing disposable razor according to claim 1, wherein said tubular handle, cartridge, positive displacement pumping mechanism, and distribution manifold all comprise molded plastic components for cost-effective mass production.

3. The gel-dispensing disposable razor according to claim 2, wherein said tubular handle is molded substantially of transparent or translucent plastic to provide an indication of the amount of gel left in said gel packet.

4. The gel-dispensing disposable razor according to claim 3, wherein said tubular handle further comprises a series of spaced rubberized annular ribs to provide a sure gripping surface.

5. The gel-dispensing disposable razor according to claim 1, wherein said handle comprises opposing slots running sidelong, and said push piston comprises a piston head slidably seated in the reservoir of said handle, and a pair of opposing finger-tabs attached to said piston head and protruding outward from said handle through said slots for manual urging of the push-piston against said gel packet.

6. The gel-dispensing disposable razor according to claim 1, wherein said distribution manifold is seated between the blade cartridge and said handle.

7. The gel-dispensing disposable razor according to claim 6, wherein said distribution manifold comprises an arcuate member with distally opposing plenums each defined by a plurality of orifices.

8. The gel-dispensing disposable razor according to claim 7, wherein said cartridge comprises a plurality of closely-spaced hypo-allergenic blades seated in a head carriage.

9. The gel-dispensing disposable razor according to claim 1, further comprising an aloe strip adhered to said head carriage proximate the blades to enhance the lubrication of the gel.

10. The gel-dispensing disposable razor according to claim 1, wherein said tubular handle comprises two opposing forked supports at one end.

11. The gel-dispensing disposable razor according to claim 10, wherein said cartridge comprises a pair of resilient clips for snap-fit coupling about the opposing forked supports of said handle.

12. The gel-dispensing disposable razor according to claim 1, wherein said gel packet comprises a foaming gel encased in a flexible sleeve.

13. The gel-dispensing disposable razor according to claim 2, wherein the flexible sleeve of said gel packet comprises a frangible end for ejecting gel when urged by said push-piston.

14. The gel-dispensing disposable razor according to claim 13, wherein said gel incorporates a fragrance.
